(19) United States
(12) Patent Application Publication
(10) Pub. No.: US 2017/0116662 A1
(43) Pub. Date: Apr. 27, 2017

(54) Systems and Methods for Remote Ordering and Payment

(71) Applicant: Satyan Ranganath, Landenberg, PA (US)

(72) Inventor: Satyan Ranganath, Landenberg, PA (US)

(73) Assignee: J.P. Morgan Chase Bank, N.A.

(21) Appl. No.: 12/489,066

(22) Filed: Jun. 22, 2009

Related U.S. Application Data
(60) Provisional application No. 61/162,169, filed on Mar. 20, 2009.

(51) Int. Cl. G06Q 30/00; G01S 1/00; G01S 5/14; G06Q 30/06

(52) U.S. Cl. CPC G06Q 30/0635

(57) ABSTRACT

The invention provides computer implemented methods and systems for fulfilling a customer request for a requested item purchased from a merchant, the method performed by a computer processing machine. The method may include inputting trigger data from a customer mobile device, the trigger data reflecting an event of the customer device, the trigger data constituting a customer request; associating the trigger data with a corresponding order record; retrieving order information from the corresponding order record, the order information including requested item information and merchant information; generating a merchant request based at least in part on the order information in the corresponding order record, the merchant request including customer identification information, merchant information reflecting a designated merchant, and requested item information; and outputting the merchant request to the designated merchant, so as to provide the designated merchant with information to fulfill the customer request.

### REFERENCED APPLICATION

This application claims priority to U.S. Provisional Patent Application 61/162,169 filed Mar. 20, 2009, the content of which is incorporated herein by reference in its entirety.

### BACKGROUND OF THE INVENTION

In the present fast paced environment, a typical person makes a wide variety of purchases in their day to day life. A variety of these purchases may become routine to a person, occurring every day or in some other periodic manner.

To support such purchases, there is a extensive financial infrastructure. For example, the credit card, and financial system associated therewith, is widely used.

However, the current financial infrastructure is lacking. The systems and methods of embodiments of the invention address these shortcomings.

### BRIEF SUMMARY OF THE INVENTION

The invention provides computer implemented methods and systems for fulfilling a customer request for a requested item purchased from a merchant, the method performed by a computer processing machine. The method may include inputting trigger data from a customer mobile device, the trigger data reflecting an event of the customer device, the trigger data constituting a customer request; associating the trigger data with a corresponding order record; retrieving order information from the corresponding order record, the order information including requested item information and merchant information; generating a merchant request based at least in part on the order information in the corresponding order record, the merchant request including customer identification information, merchant information reflecting a designated merchant, and requested item information; and outputting the merchant request to the designated merchant, so as to provide the designated merchant with information to fulfill the customer request.

### BRIEF DESCRIPTION OF THE DRAWINGS

The present invention can be more fully understood by reading the following detailed description together with the accompanying drawings, in which like reference indicators are used to designate like elements, and in which:

FIG. 1 is a block diagram showing a remote ordering system in accordance with one embodiment of the invention;

FIG. 2 is a high level flowchart showing the myorder processing in accordance with one embodiment of the invention.

FIG. 3 is a further high level flowchart showing further details of the myorder processing in accordance with one embodiment of the invention.

FIG. 4 is a flowchart showing details of the of the registration of the customer in accordance with one embodiment of the invention.

FIG. 5 is a flowchart showing in further detail the perform modifications of customer myorder record step in accordance with one embodiment of the invention.

FIG. 6 is a flowchart showing further detail the perform myorder processing based on myorder requests in accordance with one embodiment of the invention.

FIG. 7 is a flowchart showing in further detail the myorder portion observes an event that triggers the initiation of a myorder request in accordance with one embodiment of the invention.

FIG. 8 is a flowchart showing in further detail the determination performed by the myorder processing portion of whether, based on the triggering event, any further information is needed from the customer to initiate and process the myorder request in accordance with one embodiment of the invention.

FIG. 9 is a flowchart showing in further detail the processing of the transaction request is performed to secure approval to debit the customer's account for the cost of the requested item in accordance with one embodiment of the invention.

FIG. 10 is a flowchart showing details of processing to secure approval of the requested transaction, in accordance with one embodiment of the invention.

FIG. 11 is a flowchart showing in further detail processing of the merchant request in accordance with one embodiment of the invention.

FIG. 12 is a flowchart showing in further detail the merchant processes the merchant request that was sent from the myorder portion in accordance with one embodiment of the invention.

FIG. 13 is a flowchart showing in further detail the merchant worker determines if the requested item is available in accordance with one embodiment of the invention.

FIG. 14 is a block diagram showing the MO processing portion 110 in further detail, in accordance with one embodiment of the invention.

FIG. 15 is a diagram showing a customer record table 252 in accordance with one embodiment of the invention.

FIG. 16 is a diagram showing an order record table 254 in accordance with one embodiment of the invention.

FIG. 17 is a diagram showing a transaction request in accordance with one embodiment of the invention.

FIG. 18 is a diagram showing a merchant request in accordance with one embodiment of the invention.

FIG. 19 is a screen shot including an interface showing introductory information to the myorder processing in accordance with one embodiment of the invention.

FIG. 20 is a screen shot including an interface showing an interface to sign-up a customer in accordance with one embodiment of the invention.

FIG. 21 is a screen shot including an interface reflecting that the customer has successfully set up their account, and showing “favorites” that the user has selected in accordance with one embodiment of the invention.

FIG. 22 is a screen shot including an interface that provides the customer adjustment to the myorder settings in accordance with one embodiment of the invention.

FIG. 23 is a screen shot including an interface that provides the customer with a scheduling screen in accordance with one embodiment of the invention.

FIG. 24 is a screen shot including an interface that shows a queue in accordance with one embodiment of the invention.

FIG. 25 is a flowchart showing a protocol used in the processing as described herein, in accordance with one embodiment of the invention.

### DETAILED DESCRIPTION OF THE INVENTION

Hereinafter, aspects of the inventive remote ordering system in accordance with various embodiments of the invention will be described. As used herein, any term in the singular may be interpreted to be in the plural, and alternatively, any term in the plural may be interpreted to be in the singular.

The systems and methods of embodiments of the invention provide for remote payment and ordering solutions for people on the go. For example, in accordance with one embodiment of the invention, a person, i.e., a customer, is enabled to order a coffee drink with a few keystrokes on their cell phone, as they are in route to the particular merchant. That is, the customer, in accordance with one embodiment of the invention, registers with a myorder system (as described below), i.e., at some prior time. In conjunction with the registration, or at some time after registration, the customer selects “favorites” and particular merchants at which to purchase those favorites. The customer also selects an account to fund the purchase. For example, the favorites might include two coffee drinks that the customer routinely purchases. Once registration is completed, the customer is then ready to use the remote ordering system as desired, e.g. in their daily routine. By selection of the favorites, the customer is enabled to select one (or more) of the favorites by keystrokes to a customer device, e.g. a cell phone.

For example, in accordance with one embodiment of the invention, the customer is in route to the particular merchant. Once the customer has passed a particular estimated time of arrival (ETA) such as ten minutes, for example, the customer enters the predetermined keystroke (into their cell phone) so as to request their desired favorite. In response, a communication is sent to the particular merchant to proceed with preparing the customer's desired item, e.g. the customer's desired coffee drink, for example. A communication is also sent to the appropriate bank processing system, i.e., so as to effect the transaction that is to fund the purchase of the desired item.

Once the communication is received by the bank processing portion, the bank processing portion (in response) effects the transaction to fund the purchase. For example, the bank processing portion debits a predetermined credit card account of the user or in some other way effects the funds transfer (to fund the desired transaction) using any of a wide variety of payment mechanisms.

On the other hand, once the communication is received by the particular merchant, the merchant knows that the customer will be arriving shortly (e.g. in the ten minutes), and prepares the desired item accordingly. Thereafter, the customer arrives, and the coffee drink is “ready and waiting” for pick-up, having been already paid for.

In accordance with one embodiment of the invention, the initial communication from the customer device is forwarded to a “myorder” processing portion. Once received, based on the customer information in store (i.e., stored in a suitable database from the data input at customer registration), the “myorder” processing portion then forwards the appropriate communication to the merchant, as well as the appropriate communication to the bank processing system, as described above. In accordance with one embodiment of the invention, the myorder processing portion may secure authorization for the transaction from the bank processing portion prior forwarding the communication to the merchant. Note that any of a wide variety of authentication techniques may be used in the systems and methods as described herein. In particular, various techniques may be used to either authenticate the user to the merchant and/or to authenticate the user to the bank, i.e., to process a requested transaction.

In summary, in accordance with one embodiment of the invention, the remote ordering system allows a customer, with a few simple keystrokes to a cell phone, to arrange the purchase of a desired item with minimal effort, and without having to deal with any physical handling of a funds transfer. Additionally, the systems and methods of embodiments provide for various other features.

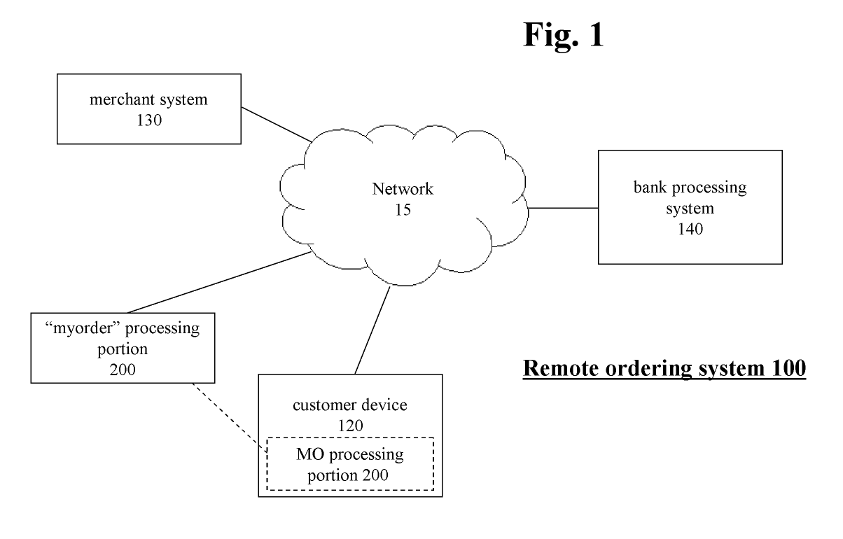

FIG. 1 is a block diagram showing a remote ordering system 100, in accordance with one embodiment of the invention. As shown, the remote ordering system 100 includes a “myorder” processing portion 200. The remote ordering system 100 further includes the customer device 120, the merchant system 130, as well as the bank processing portion 140. The various components of the remote ordering system 100 may perform the various processing as described herein. The various components of the remote ordering system 100 may communicate in any suitable manner with each other and with other systems, such as via the network 15, as shown, such as the Internet or some other network, or in any other manner.

As described above, in accordance with one embodiment of the invention, an initial communication from the customer device (e.g. sent at the time the customer is ten minutes out from the merchant) is forwarded to a “myorder” processing portion, i.e., the myorder processing portion 200. Once received, based on the customer information in store (i.e., from the customer registration), the “myorder” processing portion 200 then forwards the appropriate communication to the merchant, as well as sends an associated appropriate communication to the bank processing system.

The myorder processing portion 200 may be in various forms. For example, the myorder processing portion 200 may be a discreet processing portion, i.e., vis-à-vis the other components of the remote ordering system 100. On the other hand, the myorder processing portion 200 might be integrated into one of the portions (120, 130 and 140), either physically or from a processing perspective. For example, in accordance with one embodiment of the invention, the myorder processing portion 200 may be integrated into the customer device 120, such that the above described communications (to the merchant system 130 and bank processing portion 140) are indeed sent via the customer device 120, i.e., having been generated by the myorder processing portion 200 in response to receiving the particular keystrokes from the user. For example, the MO processing portion 200 may be a discreet processing portion in a customer's cell phone.

Alternatively, in accordance with one embodiment of the invention, the myorder processing portion 200 might be in the form of a stand alone system, such as a kiosk. In general, a kiosk may be used to provide a communication device to either the customer or the merchant. For example, the customer may be provided with a kiosk to register, select favorites, initiate a myorder as described herein, or for other communications and/or functionality.

In the example described above, the customer enters a keystroke into their cell phone to initiate the order of a desired item. However, various other arrangements may be utilized. For example, the remote ordering system 100 might utilize Global Positioning System (GPS) technology. For example, the customer's position in their car may be monitored such then when the customer comes to within a predetermined proximity of the merchant, the customer's order is automatically initiated and processed. Relatedly, an order might be triggered when the customer enters into, or passes through, a particular geographical area, i.e., when the customer drives down a particular road. In this example, as well as in the other processing as described herein, the remote ordering system 100 may utilize a variety of rules. For example, a rule might dictate that only when the customer is within proximity of the merchant during a certain time window (e.g. 6:30 am to 7:30 am on a weekday), will the order be put through. Alternatively, a rule might dictate a first item order (i.e., to be ordered) when the customer approaches the merchant on the weekday, and dictate a second item order when the customer approaches the merchant on the weekend. A wide variety of rules might be utilized as desired. Customer confirmation of the placement of a particular order might be required, based on customer preference. In accordance with one embodiment of the invention, the merchant might receive the above described communication to prepare the order, as well as a subsequent communication indicating that the customer has indeed arrived to pick up the order. Thus, the merchant might provide curb-side service to the customer using the remote ordering system 100. Various helpful information might be provided to the merchant to assist the merchant in delivering the desired item to the merchant, such as the particulars of the customer's car or a picture of the customer displayed to the merchant, i.e., so the merchant can recognize the particular customer.

In further explanation, in accordance with one embodiment of the invention, the merchant system 130, upon receipt of a “myorder,” may print a “tab” that is used by the merchant worker in preparing the requested item. The tab might be in any of a variety of forms such that information associated with the tab (by the merchant system 130) may be associated with the physical requested item. In one form, the tab might be a small sheet of paper with the needed information printed thereon. The sheet of paper might be provided with an adhesive surface so as to be affixable to the customer's purchased item, e.g. a “sticky tab” affixed to the customer's coffee drink. It is appreciated that any information regarding the customer's purchase that is contained on a printed tab may alternatively be simply provided on the merchant's system (e.g. on a computer display) and vice-a-versa. Further, there may be multiple tabs printed for a particular purchase. One tab may contain the order information with the customer's name, picture, and requested item, while a second tab (to be affixed to the same requested item) contains a targeted add. Other tabs containing other content may also be provided. Further, a single tab might contain multiple orders.

The tab that is affixed to the requested item may contain information such as time to begin to prepare the requested item, time that the requested item should be ready for pick-up, a nickname (i.e., an alias such as “RoadWarrior”) to call the customer's order out, a picture of the customer, some other manifestation of the customer such as a caricature, and/or any other information to identify the customer. Further, the information on the tab might contain other information, such as targeted add information, a “saying of the day,” information regarding the customer's account (from the bank processing portion 140), information regarding the customer's buying experience or history at the merchant (from the merchant system 130), and/or any other information that might be associated with the user (e.g. based on a user's profile) and/or useful/enjoyable by the user.

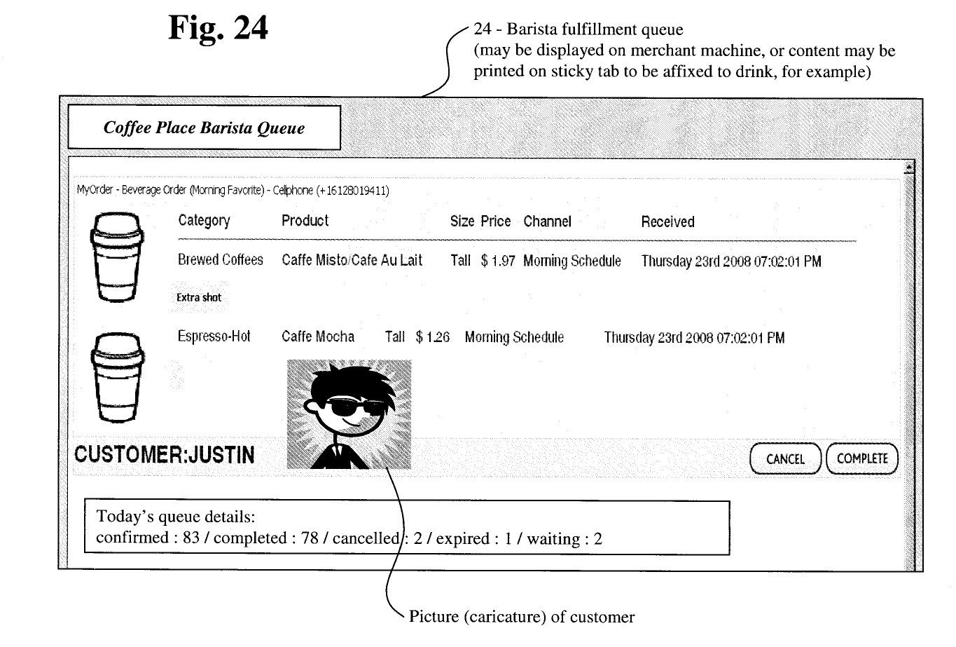

It is also appreciated that any of such information that might be printed on the tab, might also be presented in some other manner, such as via a merchant terminal, for example. FIG. 24 shows such a merchant terminal.

Relatedly, in accordance with one embodiment of the invention, the MO processing portion 200 provides for a user to upload information, i.e., any of the above described information, such that such uploaded information may be presented to the merchant as described above. For example, the customer might upload their picture so as to be displayed to the merchant worker, or so as to be printed on the tab, as described above.

In accordance with one embodiment of the invention, the placement of an order (such that the remote ordering system 100, i.e., the MO processing portion 200, forwards a respective communication to the merchant system 130 and bank processing portion 140), might be triggered by interface of the customer device 120 with a device at the merchant. For example, the customer device 120 might interface with the merchant via RFID (Radio-frequency identification) technology, such that the customer does not need to wait in line, for example.

As described above, to fund the desired transaction, the bank processing portion debits a predetermined account of the user to effect the funds transfer. It is appreciated that any of a wide variety of payment mechanisms may be used, such as credit card, debit card, stored value card, PAYPAL account, food stamps, tab, prepaid card, points card, rewards card or any other payment mechanism, the use of all of which result in a debit being accorded to an account associated with such card, i.e., such debit being in the form of monetary funds, points, or some other accounting mechanism, for example.

In conjunction with the remote ordering, it is appreciated that there may be a wide variety of communications utilized in the remote ordering system, such as between the customer and the merchant, for example. Such communications may provide various information between the customer and the merchant, for example, such as that the desired item is ready for pick-up, the name or alias of the customer to call out once the item is ready for pick-up, a time that the item will be ready for pick-up, the merchant is unable to provide the item at the current time (e.g. the coffee house is out of muffins), the customer has arrived outside the merchant's business, and/or any other desired communication/information. Such communications may be utilized to resolve the disposition of an order. For example, if a customer has not picked up a prepared requested item, a communication may be sent to the customer requesting confirmation that the customer is coming, or in some other manner resolve the disposition of the order, e.g. using a set of rules/protocols. Further, such rules/protocols may vary based on particular parameters such as the customer location, device that the customer is using, nature of the product (e.g. shelf life of the product), time of day/week, and/or customer preference, for example. Once a given number of reminders are sent, a final communication may be sent to cancel a pending order. In general, rules may be implemented to enhance the customer experience and avoid disconnects and/or shortcomings between a placed order, a paid for item that is not picked up, a customer's anticipation of an order that is not ready and/or other expectations of the customer or merchant.

The invention is described herein with reference to using a cell phone as a customer device. However, a wide variety of other customer devices and technology may be utilized, such as, for example, a PDA, land phone, smart phone, car phone, computer terminal, texting device, RFID device, GPS (Global positioning Satellite) enabled device, any other mobile device, or any other device that may provide the desired communications and functionality as described herein. Further, any communication channel or communication protocol that is associated with such a mobile device may be utilized

Such customer devices and technology may effect the communications, as described above, using any suitable data, such as numbers, characters, transmission and/or signal, for example. In particular, for example, the customer might opt for any of a wide variety of keystrokes to indicate the selection of a predetermined order.

The systems and methods of embodiments may be provided with functionality to prevent fraud. If fraud is suspected, suitable communications may be sent to the customer or other entity for investigation.

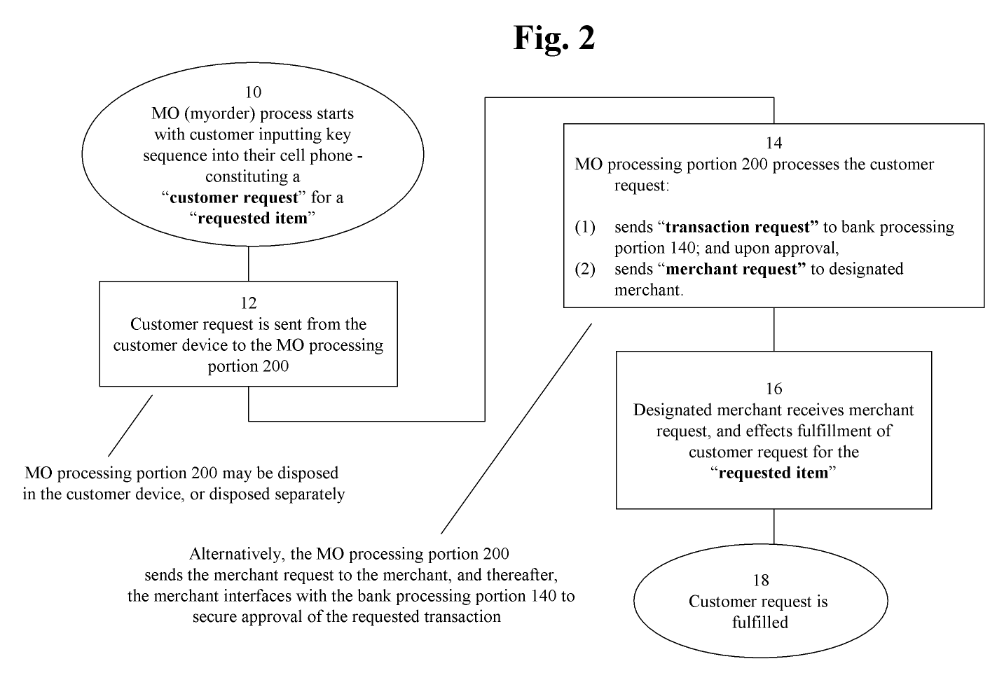

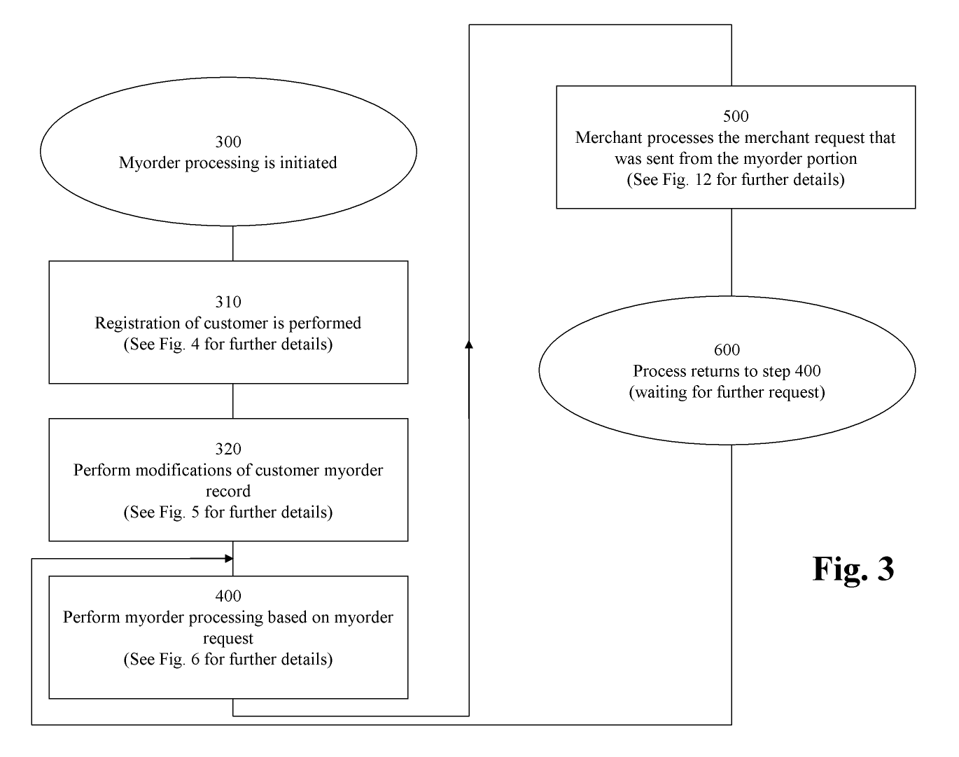

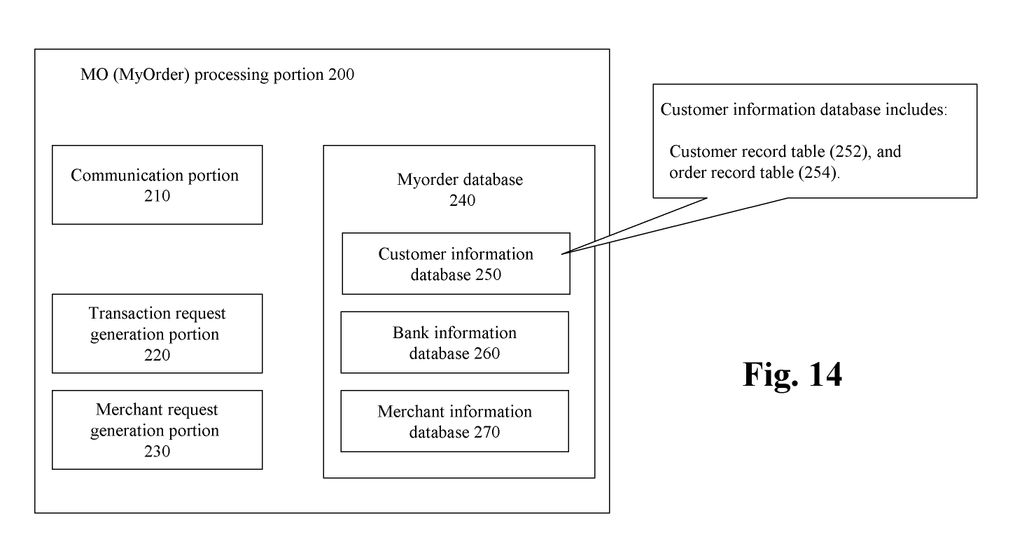

FIG. 2 is a high level flowchart showing the myorder processing in accordance with one embodiment of the invention. FIGS. 3-13 show aspects of the processing shown in FIG. 2 in further detail, as well as additional features, in accordance with one embodiment of the invention. Further, FIG. 14 is a block diagram showing the MO processing portion 110 in further detail, in accordance with one embodiment of the invention.

As shown in FIG. 14, the MO processing portion 200 [not 110] performs the various processing described herein. In addition to the processing performed by the MO processing portion 200 in general, inclusive in the MO processing portion 110 are specialized processing portions in the MO processing portion 110 that perform particular myorder processing. These specialized processing portions include the communication portion 210, the transaction request generation portion 220, the merchant request generation portion 230 and the myorder database 240.

The communication portion 210 performs various processing to provide communications between the MO processing portion 110 and other processing portions, such as the customer device 120, the merchant system 130, the bank processing portion 140, and any other system and/or resource, such as a data resource disposed on the Internet. The transaction request generation portion 220 generates a “transaction request” to be sent to the bank processing portion 140, in conjunction with a myorder request. The merchant request generation portion 230 prepares a “merchant request” to be sent to a merchant, in conjunction with a myorder request.

The myorder database 240 includes various data used and/or generated in the myorder processing. In particular, the myorder database 240 includes the customer information database 250, the bank information database 260 and the merchant information database 270, each of which are described below. In particular, the customer information database 250 includes various information about the customer including the customer profile information, i.e., customer personal information and the various customer ordering information. The bank information database 260 includes various information regarding the banks from which the funds will be drawn to fund the myorder activity of the customer. As used herein, a “bank” means any financial institution that maintains an account of the user from which funds are drawn to fund the activity as described herein. Thus, the bank information database 260 might contain the information needed to contact a particular bank in conjunction with processing a myorder request.

It is appreciated that the remote ordering system 100 may be used with a wide variety of merchants. For example, the remote ordering system 100 might be used with coffee shop related merchants, and any other quick service related merchants, for example. However, various other merchants may support the remote ordering system 100 as is desired.

It is appreciated that the myorder database 240 may use a wide variety of database structures and arrangements, such as relational database arrangements. Such database structures and arrangements may be used by the MO processing portion 200 to associate various information and to selectively parse out and use information, as needed, for example. However, in accordance with one embodiment of the invention, the customer information database 250 utilizes what is herein characterized as a “customer record table” 252 and an “order record table” 254. Various further details of the tables 252, 254 are described below.

The database 240 further includes the merchant information database 270. The merchant information database 270 includes various information regarding the merchants that participate in the myorder program, such as contact information, and menu information (what items are available through the myorder program), for example.

Hereinafter, further aspects of the processing performed by the MO processing portion 110 will be described with reference to the flowchart of FIG. 2. As described above, FIG. 2 is a high level flowchart showing the myorder processing in accordance with one embodiment of the invention. As shown in FIG. 2, the process starts in step 10, with a customer inputting a key sequence into their cell phone. This input sequence constitutes a “customer request” for a “requested item.” Then, after step 10, in step 12, the customer request is sent from the customer device to the MO processing portion 200. The MO processing portion 200 might be disposed in the customer's cell phone. Thus, step 12 would be constituted by the input key sequence being transferred from the cell phone interface portion to the MO processing portion 200, i.e., an internal transfer of data within the cell phone. Then, the process passes to step 14.

In step 14, the MO processing portion 200 processes the customer request. Such processing includes various features as described below. In particular, such processing includes the generation and output of a transaction request to the customer's bank, i.e., for approval of the requested transaction. Further, assuming approval of the requested transaction, the MO processing portion 200 then generates and outputs a merchant request, which is sent to the particular merchant from which the requested item is to be purchased. Then, the process passes to step 16. In step 16, the designated merchant receives the merchant request, and effects fulfillment of the customer request for the “requested item.” In accordance with one embodiment of the invention, the requested item is prepared and held for pickup at the counter of the particular merchant. In other embodiments, various other arrangements may be made for delivery of the requested item to the customer.

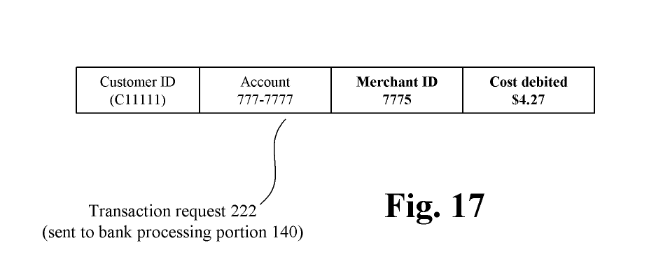

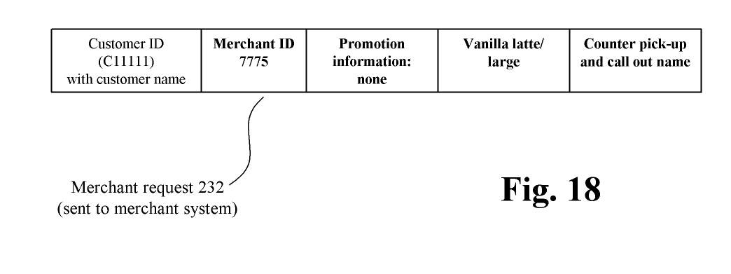

In accordance with an alternative embodiment of the invention vis-à-vis step 14 of FIG. 2, the MO processing portion 200 first transmits a merchant request to the merchant system 130, i.e., before communication with the bank processing portion 140. Thereafter, the merchant system 130 interfaces with the bank processing portion 140 to secure approval for the transaction. Accordingly, in this embodiment, the interaction between the merchant system 130 and the bank processing portion 140 might be performed in the same manner as traditional transactions, and as a result utilize known and established infrastructure between the merchant system 130 and the bank processing portion 140 so as to secure approval from the bank processing portion 140 for a requested transaction. In such an embodiment, the merchant request sent from the MO processing portion 200 to the merchant system 130 may contain information as set forth in FIGS. 17 and 18 collectively. As a result, the merchant would be provided with information it needs to satisfy the requested order, inclusive of the information needed for the merchant to secure approval of the transaction from the bank processing portion 140.

After step 16 of FIG. 2, the process passes to step 18. Step 18 reflects that the customer request is fulfilled. In conjunction with step 18, a communication might be sent to the customer acknowledging such fulfillment of the customer request for the requested item.

As noted above, in accordance with one embodiment of the invention, the customer information database 250 utilizes what is herein characterized as a customer record table 252 and an order record table 254.

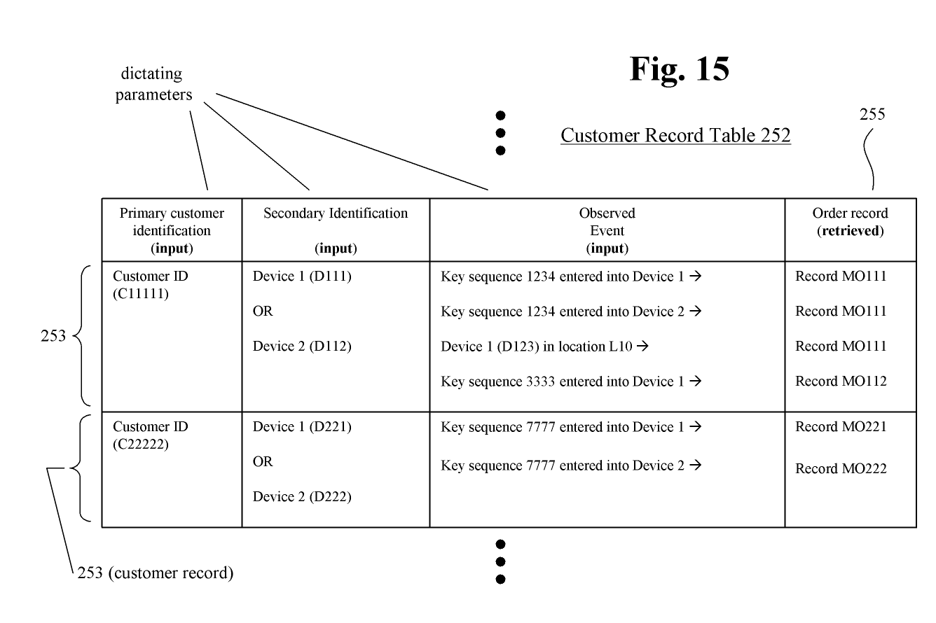

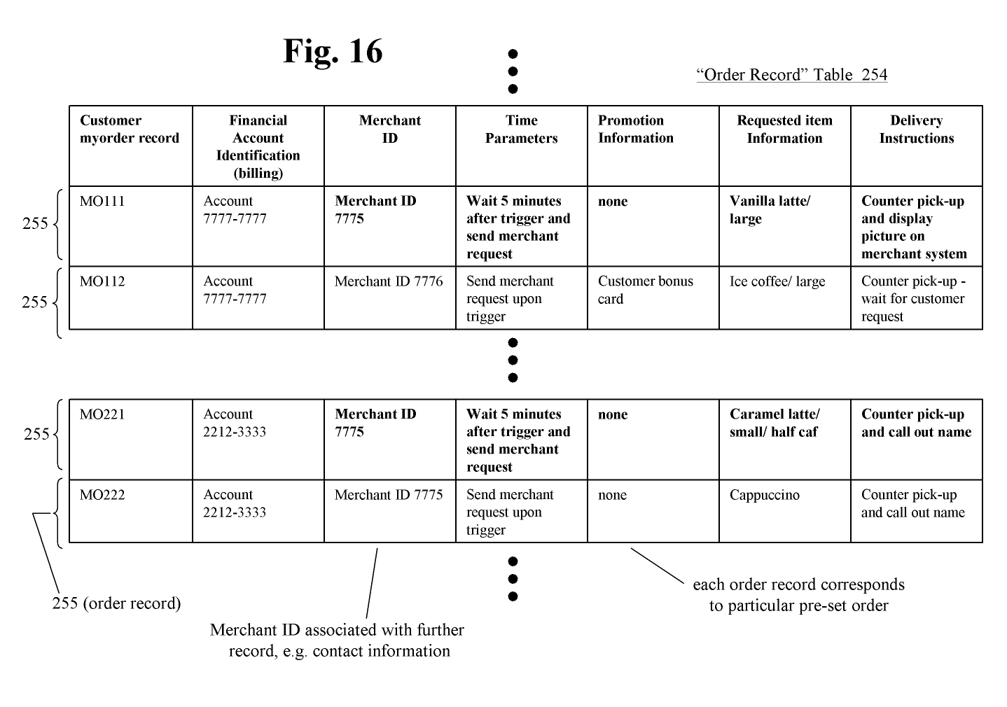

FIG. 15 is a diagram showing a customer record table 252 in accordance with one embodiment of the invention. FIG. 16 is a diagram showing an order record table 254 in accordance with one embodiment of the invention. The tables 252, 254 store various information that is used in processing of a customer request. In particular, the MO processing portion 200 use the tables 252, 254 to track data that is received from a customer device, e.g. a cell phone, into the customer data that is stored, so as to satisfy the customer's request and fulfill delivery of the requested item.

That is, in accordance with one embodiment of the invention, the customer record table 252 includes a plurality of customer records 253. Each customer record 253 corresponds to a particular customer. The customer records 253, as well as the records in the order record table 254 may number in the thousands or more. In accordance with one embodiment of the invention, each customer record 253 in the customer record table 252 includes a customer identification number, one or more customer device numbers, and one or more “events observed”. The customer record table 252 also includes a listing of order records 255. In accordance with one embodiment of the invention, a particular combination of customer number, device number, and/or observed event, results (upon the MO processing portion 200 inputting such data) in a particular order record 255 being retrieved for processing. In other words, a particular combination of customer number, device number, and/or observed event (hereinafter characterized as “dictating parameters”) is input (by the MO processing portion 200) and the MO processing portion 200 uses such input information (dictating parameters) to map to a particular order record 255. Thereafter, the particular order record 255 is retrieved, and processed so as to fulfill the customer request.

Illustratively, assume that the MO processing portion 200 is physically disposed in a banking facility. A customer generates a myorder “customer request” by calling into the myorder portion and entering in a key sequence. In such communication between the customer device 120 and the MO processing portion 200, the MO processing portion 200 also inputs the primary customer identification (C11111), the secondary identification (i.e., the device number—D111), as well as the observed event (key sequence 1234). Using the input information, the MO processing portion 200 maps such information into a particular order record 252, i.e., the order record M0111.

Once the mapping is done, the MO processing portion 200 retrieves the particular order record 255. Thereafter, the transaction request generation portion 220 (in the MO processing portion 200) generates a transaction request 222 based on the information in the order record. The generation of the transaction request 222 includes the transaction request generation portion 220 determining the requested item from the particular retrieved order record 255 and pulling further information (e.g. from stored data) to determine the cost of such item. FIG. 17 is a diagram showing a transaction request 222 in accordance with one embodiment of the invention. The transaction request 222 includes the customer ID, the account of the customer to be debited, the merchant ID, and the cost debited. Once the transaction request 222 is generated, the transaction request generation portion 220 retrieves data (based on the account number) to forward the transaction request 222 to the appropriate bank processing portion 140. Once the transaction request 222 is sent to the determined bank processing portion 140, the transaction request generation portion 220 waits for a response. Upon receiving an approval, the transaction request generation portion 220, in accordance with one embodiment of the invention, passes the processing of the particular customer request over to the merchant request generation portion 230. On the other hand, if the transaction is not approved, then the transaction request generation portion 220 takes alternative action, i.e., such as sending a communication to the customer that their request cannot be fulfilled. Such communication might include the reason for disapproval, i.e., such as conveying that there are insufficient funds.

Assuming approval of the requested transaction, the merchant request generation portion 230 then generates a merchant request 232. The merchant request 232 is prepared to convey the needed details of the customer request to the designated merchant, i.e., the merchant that will satisfy the customer request and prepare the requested item for pick-up by the customer.

FIG. 18 is a diagram showing a merchant request 232, in accordance with one embodiment of the invention. In generation of the merchant request 232, the merchant request generation portion 230 pulls (uses) information from both the customer record table 252 and the mapped to order record 255 in the order record table 254. Illustratively, in this example, the merchant request 232 includes the customer ID with customer name, the merchant ID, any promotion information (to be documented by the merchant), the particular requested item, and the delivery instructions. Once the merchant request 232 is generated, the merchant request generation portion 230 sends the merchant request 232 to the particular merchant. For example, the merchant request generation portion 230 might pull contact information for the merchant from a database (containing such information) based on the merchant ID.

The merchant, upon receiving the merchant request 232, works to satisfy the customer request.

It is appreciated that FIG. 15 and FIG. 16, as described above, reflect one methodology that may be used to input a customer request, including a key sequence, and map that input sequence to information so as to fulfill the customer request. However, other approaches may be used to associate data input from the customer with information—so as to fulfill the customer request that such input data reflects. In particular, other arrangements of relational databases might be utilized to associate information input from a customer with the information needed to satisfy a customer request.

Further, it is appreciated that different data may be used and/or needed, to map to a particular order record in the order record table 254. For example, in accordance with one embodiment of the invention, the MO processing portion 200 is physically disposed in the customer's device, e.g. in the customer's cell phone. In such embodiment, customer might enter an initial key sequence to reflect that the customer is initiating a myorder request. Thereafter, the MO processing portion 200 would be activated and looking for input of a key sequence from the customer. Once the MO processing portion 200 receives such key sequence (i.e., out of a plurality of possible key sequences), the MO processing portion 200 proceeds in processing the myorder request. That is, the customer device need not transmit customer ID information or device Id information to the MO processing portion 200, since the MO processing portion 200 indeed only receives myorder requests from such device. Accordingly, the information needed to be sent between and stored within either the customer device 120 and the MO processing portion 200 may vary depending on the particular arrangement.

In accordance with one embodiment of the invention, using a suitable user interface, the parameters (or at least some of the parameters) in the order record table 254 may be changed by the customer, an administrator, or changed in some automated manner. For example, it is envisioned that promotion parameters might be changed in some global manner, i.e., so as to globally change all order record tables 254 affected by the change to a merchant's promotion, for example. Alternatively, promotion information, as well as pricing information, might be pulled from an associated table based on the merchant ID and the requested item, for example. The customer also would be able to change their favorites and/or the particular key sequence or other observed event that such favorite is associated with.

As reflected in the first customer record 253, in the customer record table 252, (i.e., customer record for customer C11111), customer requests from different devices of the customer and/or customer requests based on different observed events may be mapped into the same order record. That is, illustratively, for the customer record C1111 as shown in FIG. 15, a customer request from any of: key sequence 1234 in customer device 1; key sequence 1234 in customer device 2, and customer device 1 in location L10, will all track into order record MO111. Thus, for any of such observed events, the MO processing portion 200 processes a customer request using such order record 255. In general, the MO processing portion 200 uses the dictating parameters, as input from the customer, to map to a particular order record 255.

As described herein, a user interfaces with the customer device 120 using a “key sequence” entered into the customer device by the user. However, it should be appreciated that the user may interface with their customer device 120 in any of a wide variety of ways, depending in particular on the capabilities of the device and/or what software applications are utilized by the customer device 120 to interface with the user. Accordingly, for any of the functionalities described herein (including those described in the context of using a key sequence), the customer device 120 might interface with the user using any of key sequence, presentation of icons or other graphical representation, touch screen, voice recognition, a device utilizing textile features, LED (light-emitting diode) enabled device, push notification enabled device, media message enabled device and/or any other type of user interface that allows the user to communicate information to and from the customer device 120. For example, in accordance with one embodiment of the invention, the customer device 120 might present a first icon (reflecting an option to purchase their favorite coffee at their favorite store), a second icon (reflecting an option to purchase their second favorite coffee at their favorite store), and a third icon (reflecting an option to purchase their favorite coffee at their second favorite store). The icons might be associated with the letters A, B, and C, respectively, such that the customer makes their selection by entering either A, B or C into their key pad on the customer device 120.

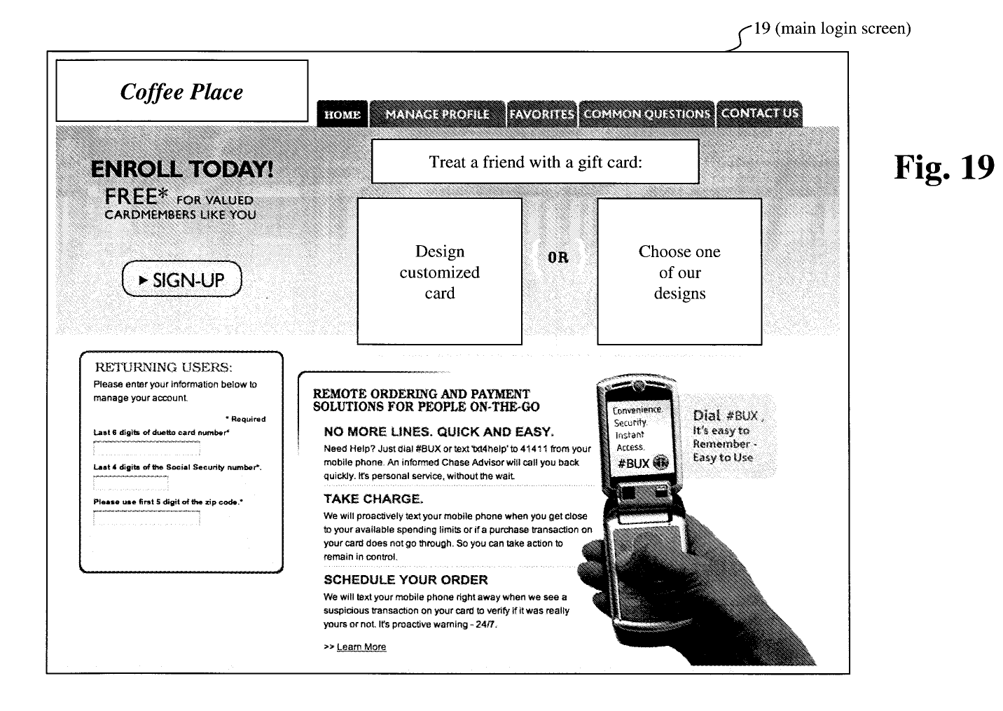

FIG. 19-FIG. 25 are screen shots showing interfaces of myorder processing in accordance with embodiments of the invention. The information presented in the illustrated interfaces may be generated by the MO processing portion 200 and/or pulled from a further resource, so as to be displayed on the customer device 120.

FIG. 19 is a screen shot including an interface 19 showing introductory information to the myorder processing. In particular, FIG. 19 provides for initial sign-up of a customer, as well as a dialogue box that returning customer's may use to access their account. FIG. 19 also presents introductory information regarding the myorder processing.

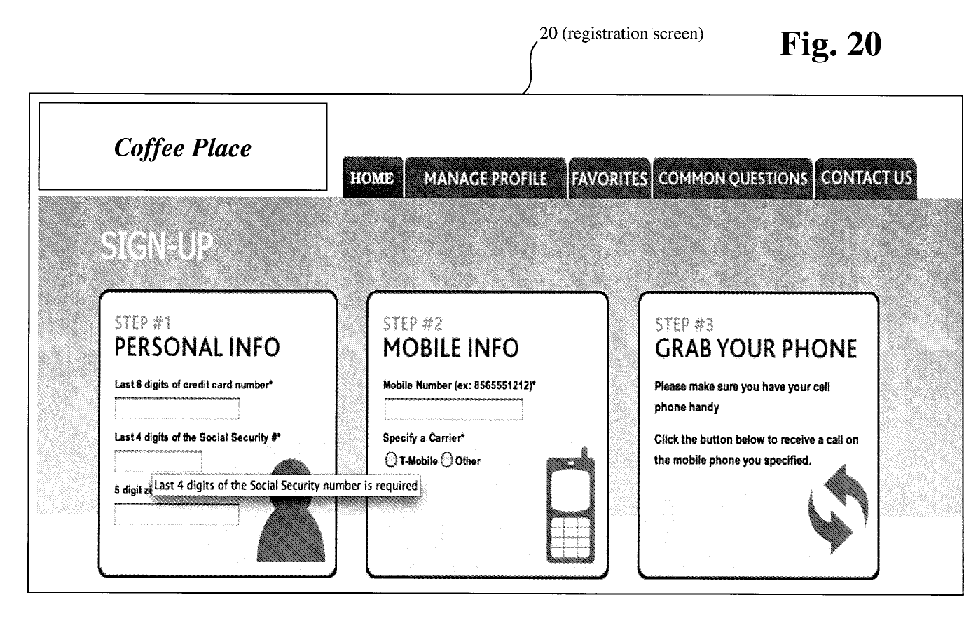

FIG. 20 is a screen shot including an interface 19 showing an interface to sign-up a customer. The interface gathers information from the customer including personal information and mobile information. Once the initial information is entered via the screen shot 20, the customer with then be prompted to enter further information.

It is appreciated that in general the information as shown in FIGS. 19-24 may be presented through a variety of user interfaces as generated by the devices described herein.

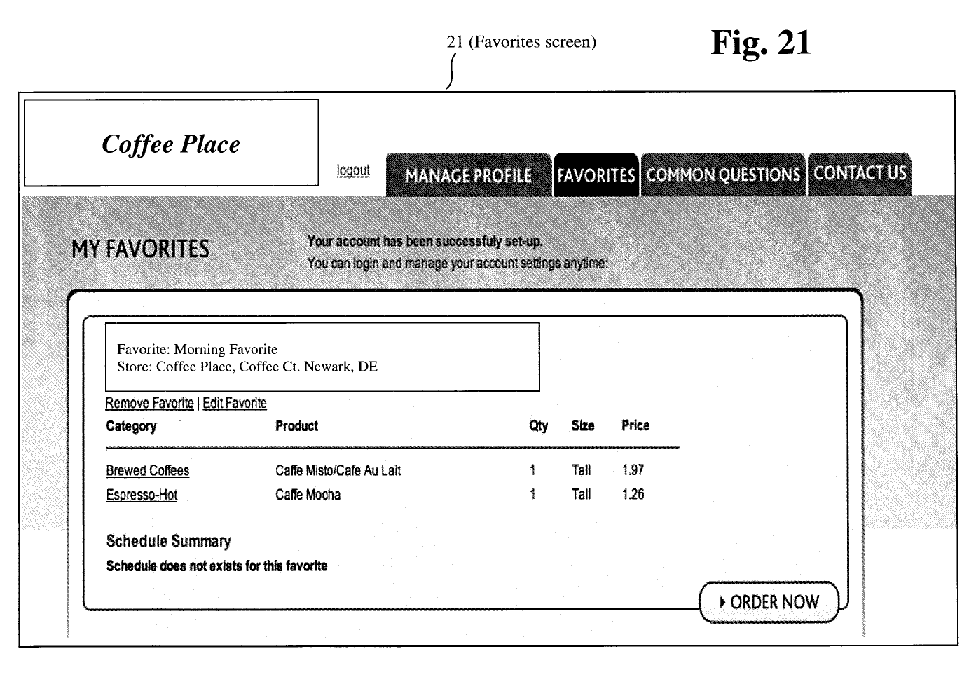

In particular, FIG. 21 is a screen shot including an interface 21 reflecting that the customer has successfully set up their account, and showing “favorites” that the user has selected. More specifically, the interface 21 allows the customer to edit their “favorite” selections and to order if the customer desires.

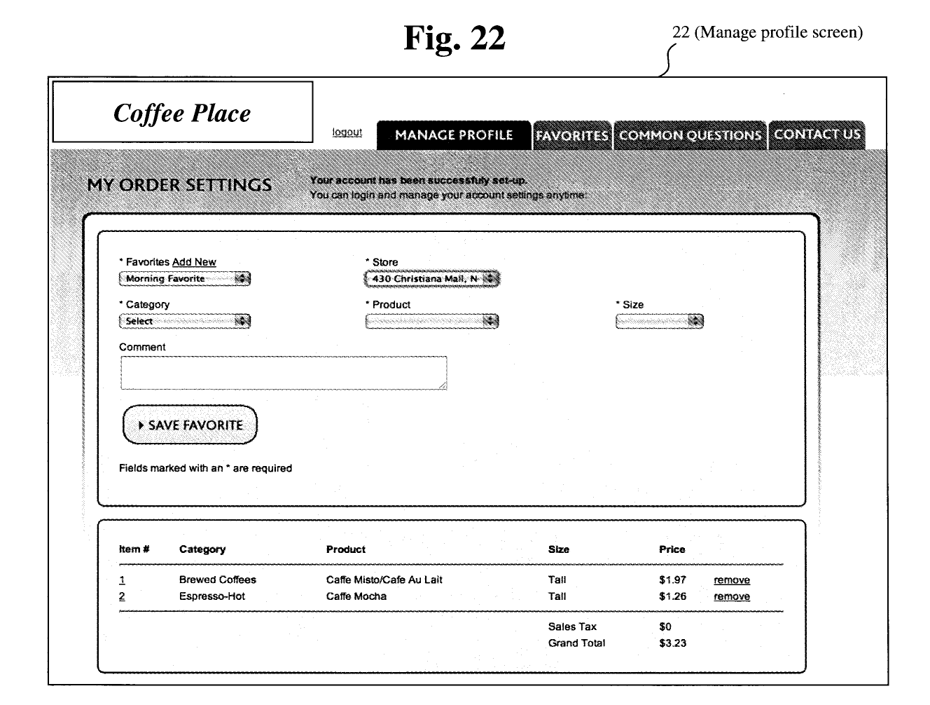

FIG. 22 is a screen shot including an interface 22 that provides the customer adjustment to the myorder settings. The interface 22 allows a customer to add new favorites, and associated parameters, as well as to specify a particular store location. The interface 22 also presents the user with a listing of the favorites that the user has selected.

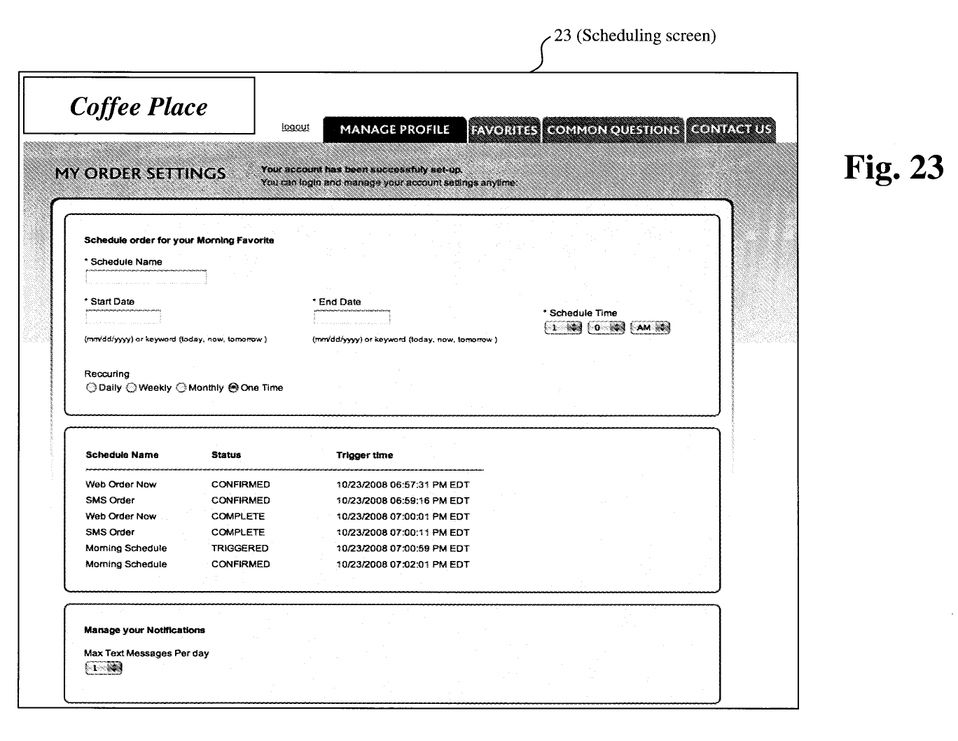

FIG. 23 is a screen shot including an interface 23 that provides the customer with a scheduling screen. The interface 23 allows the customer to schedule orders and to set up trigger events. For example, in accordance with embodiments of the invention, the interface 23 might allow the customer to schedule a particular time for pick-up of a requested item, order using a particular key sequence via a cell phone or PDA, order via a web interface, select an order based on GPS position of the customer, and/or associate time parameters with such order.

In accordance with one embodiment of the invention, the remote ordering system 100, e.g. the MO processing portion 200 may include data to present the user with template schedules. Such template schedules might include any of a wide variety of common regimes for customers, such as 8 am coffee every weekday, and 9 am coffee on Saturdays, for example. The templates might be presented to the user so as to be variable, i.e., the user could adjust the templates proposed 8 am time to 7 am, for example. The template schedules might be selected (out of a plurality of presented template schedules) via the user's selection of a radio-button, for example. The template schedules might be customized in any of a variety of ways, such as customized for open times of a particular store, customized for a particular time, for example. Further, the remote ordering system 100 may provide for a first customer's schedule to be linked to another customer's calendar, i.e., the two customers' schedules might synch with each other or in some other manner talk with each other. Such processing might utilize GOOGLE CALENDAR technology, for example. Alternatively, a user might manually enter in their schedule using an appropriate interface. In general, it is appreciated that a customer's ordering regime may be integrated into their calendar, the merchant's calendar, or any other electronic calendar, as desired.

Further, FIG. 24 is a screen shot showing a “barista fulfillment queue” interface 24, in accordance with one embodiment of the invention. The interface 24 is presented to the merchant in response to a myorder being placed by the customer. The interface 24 presents various particulars of the placed order including the customer name, the particular item purchased and the time that the myorder was received. It is appreciated that the particular content the of the interface 24 may be varied, as desired.

Further, as described above, the content shown in FIG. 24 may alternatively be printed on a tab to be attached to the customer's requested item, e.g. a sticky tab affixed to the customer's coffee drink.

As shown in FIG. 24, the data presented may also include particulars of the order of the merchant for that day, i.e., “confirmed” orders meaning that customers were notified of their pending order and indicated they indeed wanted their scheduled order on that particular day; “completed” meaning that the order was indeed delivered to the customer; “canceled” meaning that the customer canceled their order; “expired” meaning that the customer never picked up their order (or never confirmed their order—where confirmation was required); and “waiting” indicating that the order is ready for pick-up by the customer. However, it is appreciated that any of a wide variety of metrics may be captured and presented to the merchant, as is desired, i.e., so as to assist the merchant in their workflow.

Various further aspects of FIG. 19-FIG. 25 are described further below.

Hereinafter, further details of the myorder processing are described with reference to the flowcharts of FIGS. 3-13, in accordance with one embodiment of the invention.

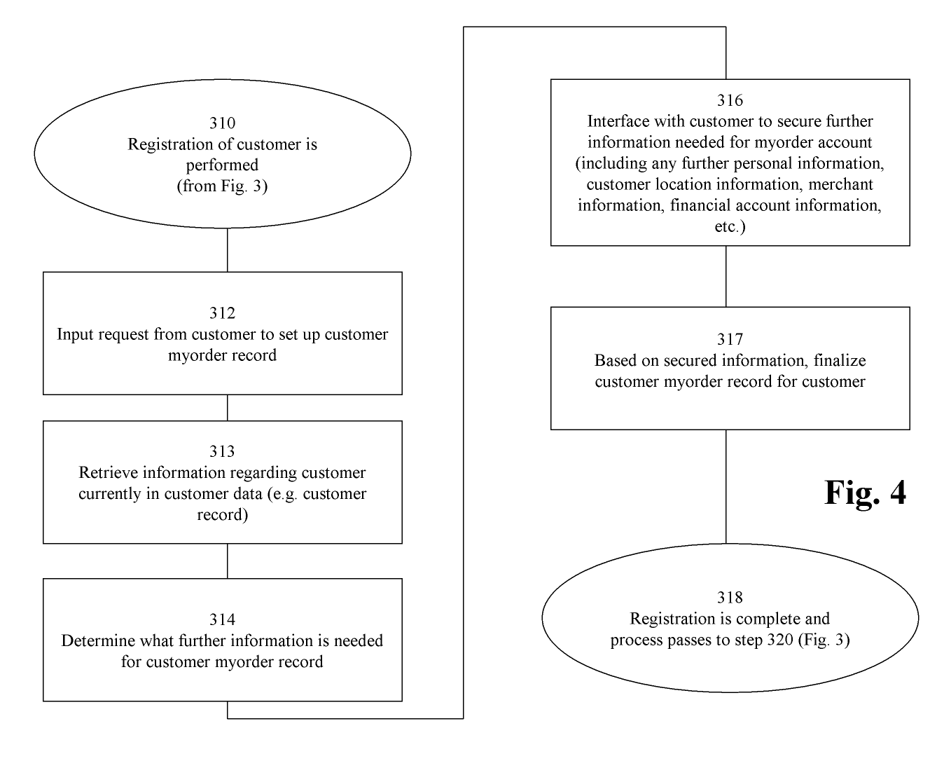

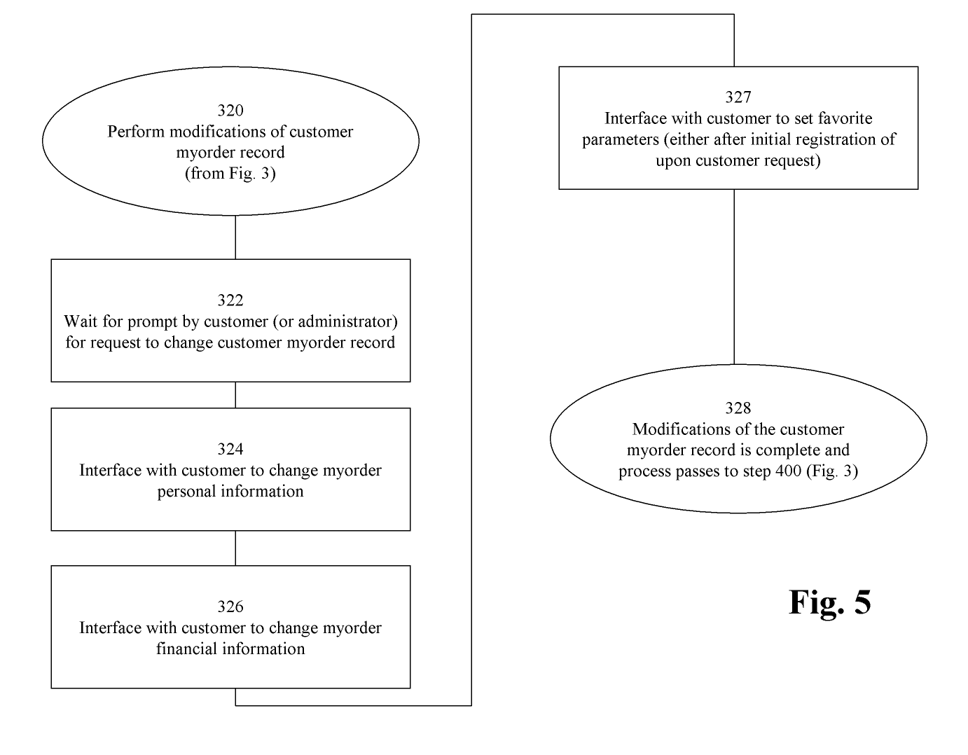

Illustratively, the process starts in step 300 of FIG. 3 in which a myorder processing is initiated. After step 300, the process passes to step 310. In step 310 registration of the customer is performed. Further details of step 310 are described below with reference to FIG. 4. Then, as shown in FIG. 3, the process passes to step 320. In step 320 modifications of the customer myorder record are performed. For example, modifications of the customer myorder record may be performed upon a customer request, upon an administrators request, or due to some other triggering event. Further details of the processing of step 320 are described below with reference to FIG. 5. Then, the process passes to step 400.

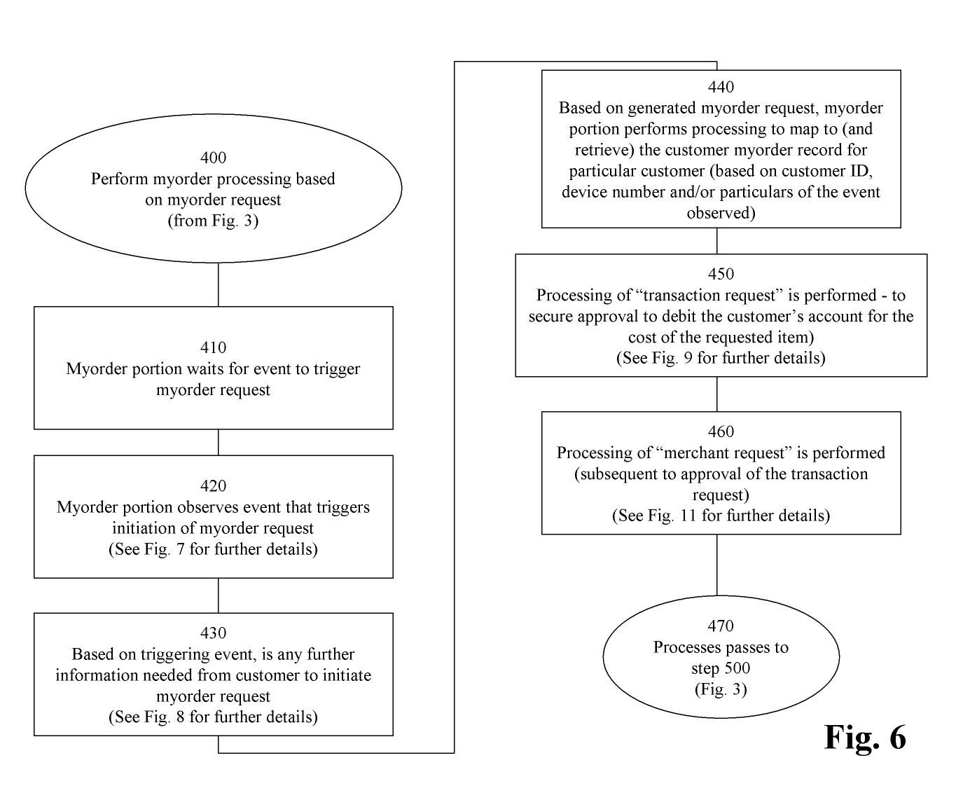

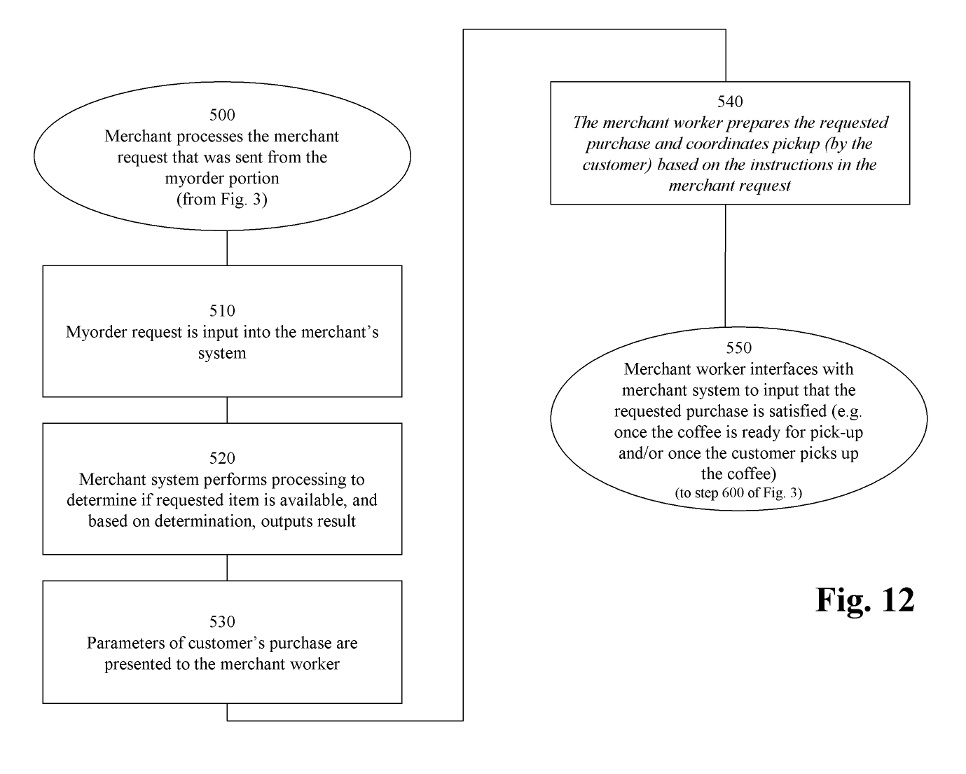

In step 400 of FIG. 3, myorder processing is performed based on a myorder request that was received from the customer. Various details of such myorder processing are described below with reference to FIG. 6. After step 400, and after a merchant request is sent from the myorder portion to a merchant, as described below, the process passes to step 500. In step 500, the merchant (which received the request) processes the merchant request that was sent from the myorder portion. Further details of such processing are described below with reference to FIG. 12. Then, after step 500 of FIG. 3, the process passes to step 600.

In step 600, the process returns to step 400 and waits for further requests, i.e. from the customer.

FIG. 4 is a flowchart showing details of the of the registration of the customer step 310, in accordance with one embodiment of the invention. As shown in FIG. 4, the process starts in step 310 and passes to step 312. In step 312, an input is requested from the customer to setup a customer myorder record. Then, in step 313, the myorder portion (e, the MO processing portion 200) retrieves information regarding the customer that is currently in the customer data which the financial institution supporting the myorder portion already possesses. That is, for a customer having a current savings account, available information that was relevant to the myorder portion would be retrieved. Then, in step 314, a determination is made what further information is needed to set up the customer myorder record i.e. the customer myorder account. Then in step 316, the system interfaces with the customer to secure such further needed information including any further personal information, customer location information, merchant information, and financial account information, as well as a wide variety of other information used in the processing of the myorder processing portion. Then, the process passes to step 317, in which the myorder processing portion, based on the information secured from the banks database and from the customer, finalizes the customer myorder record for the customer.

After step 317 of FIG. 4, the process passes to step 318. In step 318, the registration is complete and the process passes to step 320 of FIG. 3, i.e., the process returns to FIG. 3.

FIG. 5 is a flowchart showing in further detail the performed modifications of customer myorder record step 320 (from FIG. 3) in accordance with one embodiment of the invention. The process of FIG. 5 starts in step 320 and passes to step 322. In step 322, the process waits for a prompt by the customer for a request to change the customer myorder record. Alternatively, a prompt might be received from an administrator or in general a system prompt may be received to trigger a modification of the customer myorder record. For example, the system might modify the customer myorder record based on some observed event or criteria. After step 322 of FIG. 5, the process passes to step 324. In step 324, the system interfaces with the customer to change myorder personal information. Further, the system may interface with a customer in step 326 to change the myorder financial information. It should be appreciated that any a variety of information might be changed. Step 327 reflects that the customer may interface with the systems to set favorite parameters i.e. such as key sequences to represent their personal favorites. Note that this is typically done after registration as well as in due course through the life of the myorder account.

Step 328 of FIG. 5 reflects that modifications of the customer myorder record are complete and the process passes to step 400 of FIG. 3.

FIG. 6 is a flowchart showing further detail the perform myorder processing based on myorder requests (from FIG. 3) in accordance with one embodiment of the invention. As shown in FIG. 6, the process starts in step 400 and passes to step 410. In step 410, the myorder portion 200 awaits for an event to trigger a myorder request. Upon an event being observed, the process passes to step 420. In step 420, the myorder portion observes the event that triggers the initiation of a myorder request. Further details of step 420 are described below. Then, in step 430 of FIG. 6, the system, based on the triggering event, determines if any further information is needed from the customer to initiate and process the myorder request. Further details of step 430 are described below.

After step 430, the process passes to step 440 of FIG. 6. In step 440, the system, based on the information received in the generated myorder request, performs processing to map to and retrieve the appropriate corresponding order record 254 for the particular customer. This mapping may be based on any suitable criteria as described above, and in particular, for example, based on the customer ID, the device number that the customer is using, and/or particulars of the event observed. For example, it might be that a particular key sequence is unique to a particular customer. In accordance with one embodiment of the invention, the system maps to the particular order record 254 based on all of the customer ID, the device number as well as the particulars of the event observed.

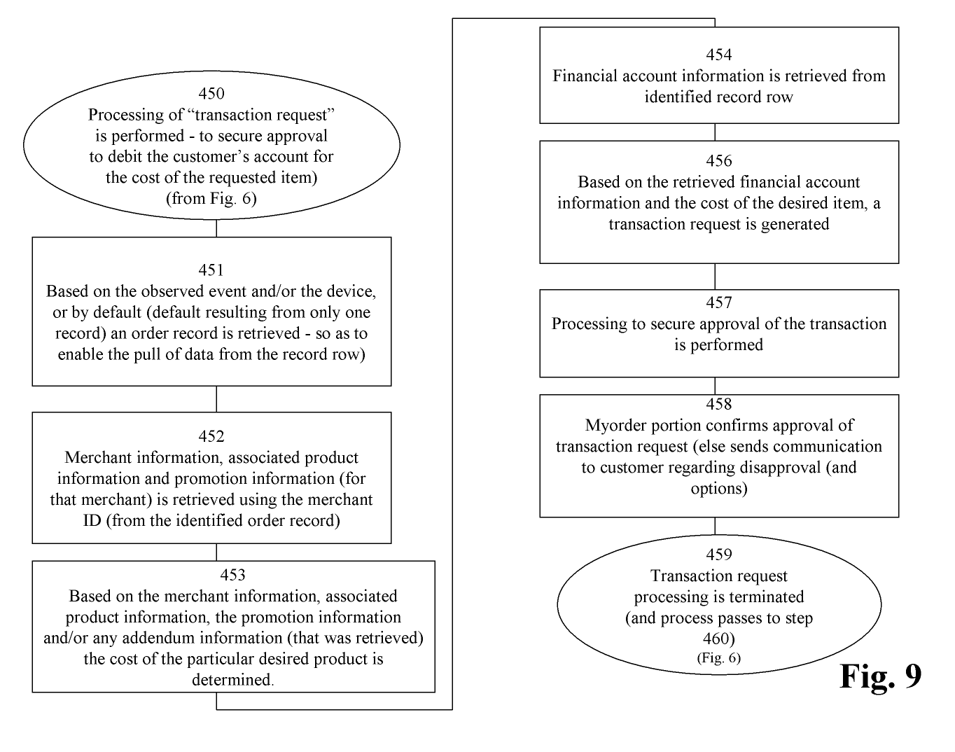

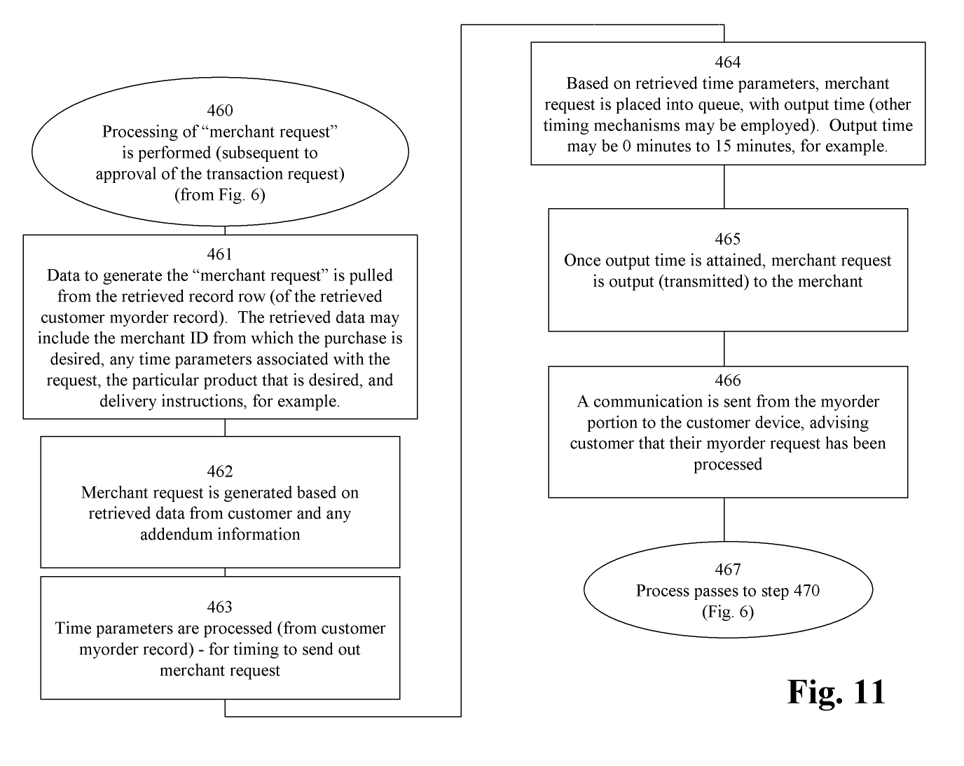

After step 440 of FIG. 6, the process passes to step 450. In step 450, processing of the transaction request is performed to secure approval so as to debit the customer's account for the cost of the item that the customer has requested. Further details of step 450 are described below with reference to FIG. 9. Then, in step 460, processing of the “merchant request” is performed. Further details of step 460 are described below with reference to FIG. 11. The processing of the merchant request is performed subsequent to the approval of the transaction request. After step 460 of FIG. 6, the process passes to step 470. In step 470, the process passes to step 500 of FIG. 3.

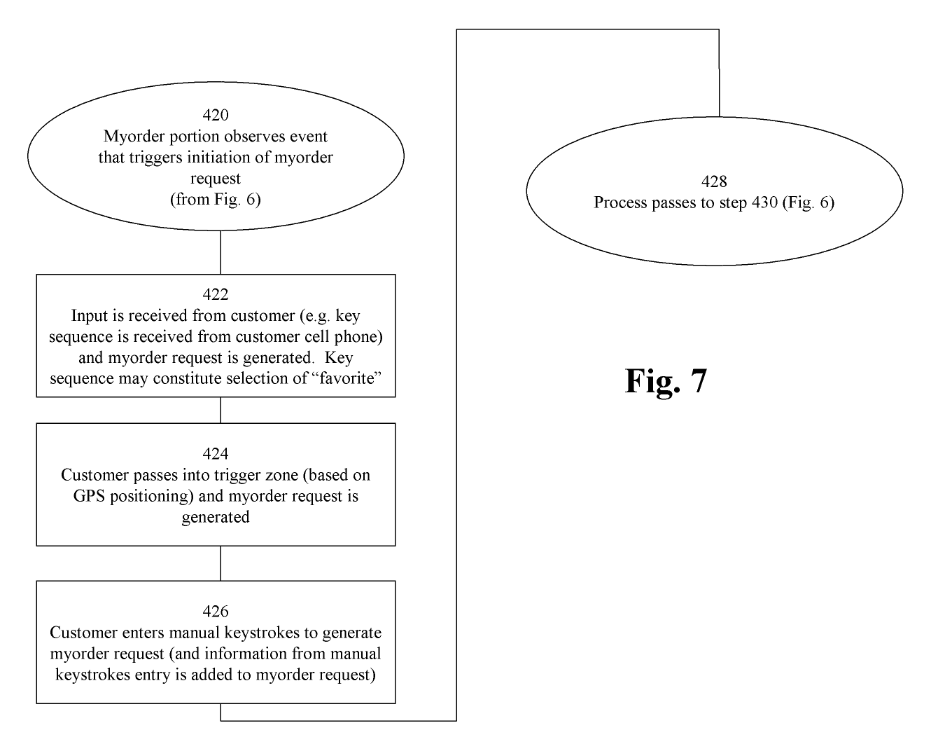

FIG. 7 is a flowchart showing in further detail the myorder portion observes an event that triggers the initiation of a myorder request. As shown in FIG. 7, the process starts in step 420, and passes to step 422. In step 422, the input is received from the customer. For example, a key sequence may be received from the customer's cell phone and as a result, a myorder request is generated. In accordance with one embodiment of the invention, the key sequence may constitute the selection by the customer of one of the customer favorites. For example, the key sequence 1, 2, 3, 4 may correspond to a large vanilla latte being ordered by the customer. However, FIG. 7 reflects other types of trigger events. For example, as shown in step 424, the customer may pass into a trigger zone such that the myorder request is generated. For example, the location of the customer's cell phone vis-à-vis a trigger zone may utilize global positioning technology, so as to trigger a myorder. Further, step 426 reflects that the customer may enter manual key strokes to generate their myorder request. Any information obtained from the manual key strokes entered by the customer would be added to the myorder request for subsequent processing. For example, step 426 reflects that the user might interface with a menu screen so as to advance through various categories and selections of items.

After step 426 of FIG. 7, the process passes to step 428. In step 428, the process passes to step 430 of FIG. 6.

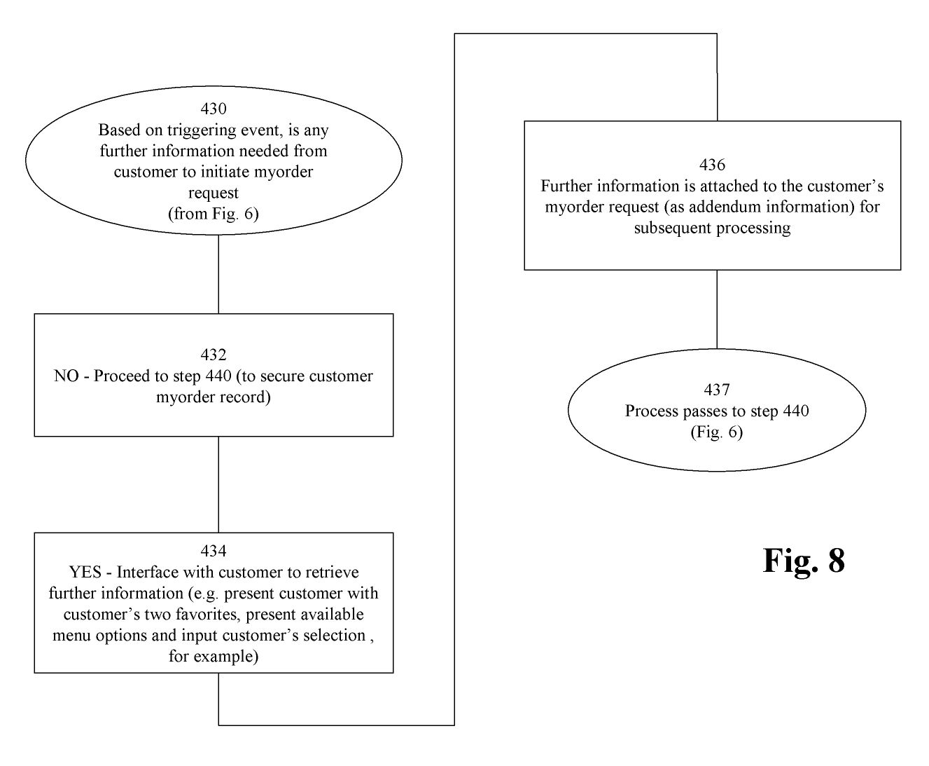

FIG. 8 is a flowchart showing in further detail the processing of FIG. 6, i.e., the determination performed by the myorder processing portion of whether, based on the triggering event, any further information is needed from the customer to initiate and process the myorder request. Step 432 reflects that no further information is needed, and the process passes directly to step 440 of FIG. 6. Then, in step 437, the process passes to step 440 of FIG. 6.

Alternatively, step 434 reflects that further information is needed, and the MO processing portion 200 interfaces with the customer to secure such further information. After step 434 of FIG. 436, in step 436, the further information is attached to the customer's myorder request (as addendum information, e.g.) for subsequent processing.

FIG. 9 is a flowchart showing in further detail the processing of the transaction request is performed to secure approval to debit the customer's account for the cost of the requested item, of FIG. 6 as described above. As shown in FIG. 9, after the process starts in step 450, the process passes to step 451. In step 451, the system retrieves a particular “order record” 255 for the customer. That is, based on the observed event the particular device that the customer has used, and/or by default, i.e. there is only one record row in the customer myorder record an order record is retrieved. Accordingly, in step 451, the system maps to the order record, pulls the data from the particular order record, or in some other way provides access to the data in the particular order record of the customer myorder record. After step 451 of FIG. 9, the process passes to step 452. In step 452, the merchant information, associated product information, as well as any promotion information or targeted add, for example, is retrieved using the merchant ID from the identified order record.

After step 452, the process passes to step 453. In step 453, based on the merchant information, the associated product information, as well as any promotion information, and any additional information that was retrieved, the cost of the particular desired item is determined. Then, in step 454, the financial account information is retrieved from the identified record row. Then, in step 456, based on the retrieved financial account information and the cost of the desired item, and transaction request is generated. Then, in step 457, processing is performed to secure approval of the transaction. That is, for example, the myorder processing portion communicates with an authorization entity to determine if the transaction is approved. After step 457 of FIG. 9, the process passes to step 458. In step 458, the myorder portion confirms approval of the transaction request. Otherwise, if the transaction request is not approved for the customer, the authorization entity and/or the myorder processing portion may communicate such disposition of the customers account. Such communication may provide alternative options to the customer, such as entering a credit card number. After step 458, the process passes to step 459. In step 459, the transaction request processing is terminated and the process passes to step 460 of FIG. 6.

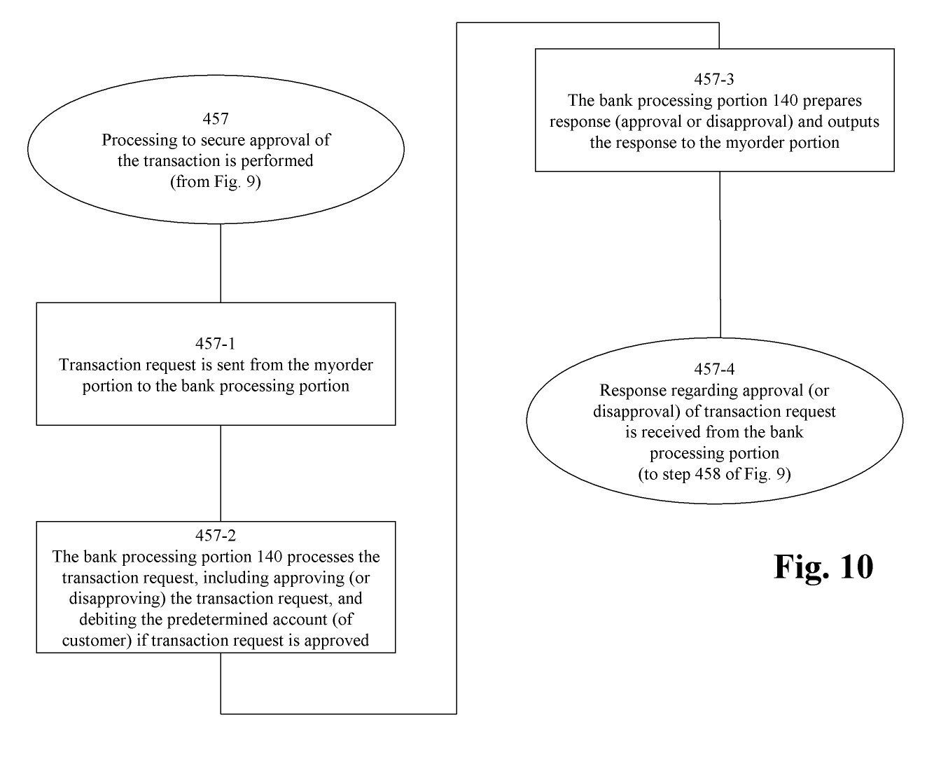

FIG. 10 is a flowchart showing details of step 457 in which processing is performed to secure approval of the requested transaction, in accordance with one embodiment of the invention. After starting in step 457, the process passes to step 457-1 in which the transaction request is sent from the myorder portion to the bank processing portion. Then, in step 457-2, the bank processing portion 140 processes the transaction request, including approving (or disapproving) the transaction request, and debiting the predetermined account (of customer) if transaction request is approved In step 457-3, the bank processing portion 140 prepares response (approval or disapproval) and outputs the response to the myorder portion. Then, in step 457-4, the response, approval or disapproval, is received from the bank processing portion 140 by the MO processing portion 200. The process then returns to step 458 of FIG. 9.

FIG. 11 is a flowchart showing in further detail the processing of the merchant request is performed step 460 from FIG. 6, i.e. subsequent to approval of the transaction request. The process of FIG. 11 starts in step 460, and passes to step 461.

In step 461, data to generate the merchant request is pulled from the retrieved order record 255 of the retrieved customer myorder account. The retrieved data may include the merchant ID from which the purchase is desired, any time parameters associated with the request, the particular product that is desired, delivery instructions, as well as any other information. After step 461, the process passes to step 462. In step 462, the merchant request is generated based on the retrieved data from the order record 255 and any addendum information i.e. any information the customer entered in manually, for example. Then, in step 463, time parameters set forth in the record row are processed. That is, these time parameters reflect the timing in which the merchant request is to be sent out. Then, in step 464, based on the retrieved time parameters, the merchant request is placed into queue with an output time. For example, the output time may be 0 minutes, i.e. immediately or 15 minutes, for example. It is appreciated that various other timing mechanisms may be utilized. For example, if the time parameters are such that the merchant request should be immediately forwarded to the designated merchant, then no placement into queue is desired. After step 464, the process passes to step 465.

In step 465, once the output time is attained for the merchant request that is in queue, the merchant request is output i.e. transmitted to the merchant. Then, in step 466, a communication is sent from the myorder portion to the customer device. This communication may include various information and in particular advise the customer that their myorder request has been processed. Then, in step 467, the process passes to step 470 of FIG. 6.

FIG. 12 is a flowchart showing in further detail the step 500 of FIG. 3, i.e., merchant processes the merchant request that was sent from the myorder portion. That is, step 500 reflects the processing that is performed at the merchant, after that merchant receives a merchant request from the myorder processing portion.

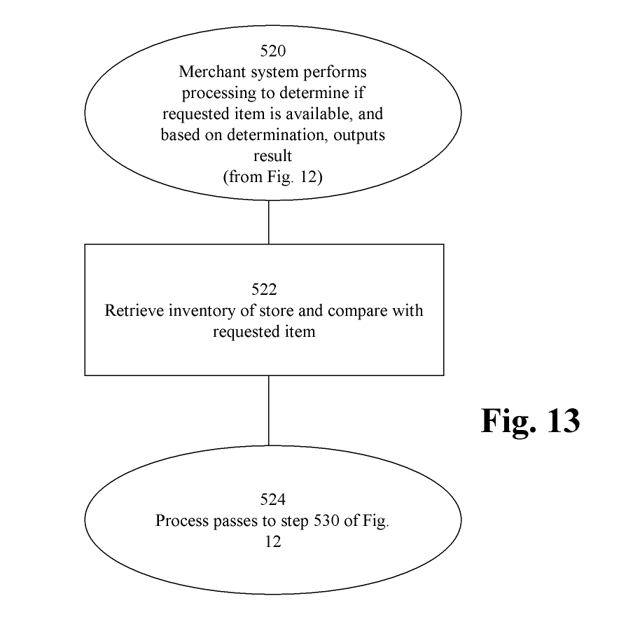

After step 500 of FIG. 12, the process passes to step 510. In step 510, the myorder request, i.e. the merchant request, is input into the merchant system. Then, in step 520, the merchant system performs processing to determine if the requested item is available. Based on that determination, an output may be generated in the form of a communication to the customer device. FIG. 13, described below, shows further detail of such communication. After step 520 of FIG. 12, the process passes to step 530.

In step 530, the parameters of the customers purchase are presented to the merchant worker. Then, in step 540, the merchant worker prepares the requested purchase and coordinates the pickup of the purchase (by the customer) based on the instructions that the worker sees in the merchant request. After step 540, the process passes to step 550. In step 550, the merchant worker interfaces with the merchant system to input that the requested purchase is satisfied. Accordingly, step 550, may reflect that the requested purchase is satisfied, i.e., once the requested item is ready for pickup and/or once the customer picks up the requested item.

FIG. 13 is a flowchart showing in further detail step 520 in which the worker determines if the requested item is available. After the process starts in step 520, the process passes to step 522. In step 522, the processing retrieves the inventory of the merchant, and determines if the requested item may be satisfied. Then, the process passes to step 524, passes to step 530 of FIG. 12, and continues as described above.

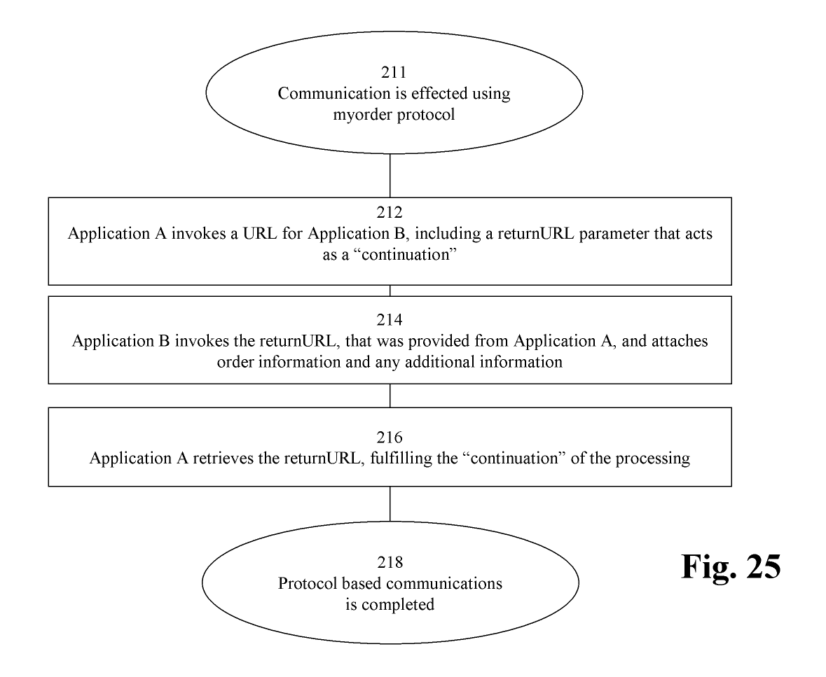

FIG. 25 is a flowchart showing a protocol, i.e., a myorder protocol, used in the processing as described herein, in accordance with one embodiment of the invention. That is FIG. 25 sets forth a protocol which may be utilized in the various communications as described herein in conjunction with the myorder processing.

In summary, the protocol may be characterized as “go somewhere; do something; come back.” The various systems and processing, and associated communications, as described herein may be provided with and/or utilize such protocol so as to provide a richer and more automated platform.

After the protocol is initiated in step 211 of FIG. 25, the processing passes to step 212. As shown in step 212, a first application, i.e., application A, invokes a URL for a second application, i.e., Application B, including a returnURL parameter that acts as a “continuation”. To explain further, in accordance with one embodiment of the invention, when a customer (using the protocol) taps “Coffee Thru MyOrder” in a SmartPhone (or other mobile customer device) application A crafts a URL (for the MyOrder processing). The customer can specify various parameters, and application A will reflect such on the URL query string, i.e., and fill in the appropriate values on the query string to reflect such selected parameters.

Application A, as described, may be constituted by the MO processing portion 200, with application B constituted by the merchant system 130. For example, the communication portion 210 and/or merchant request generation portion 230 in the MO processing portion 200 may effect the protocol related processing as described herein.

The calling application (application A) also includes a returnURL parameter so that application B knows how to come back when the processing is done. The returnURL contains all the information the calling application (application A) needs to continue the progression of processing between application A and application B. In one case the URL sent by application A may include a simple beverage_id parameter, i.e., so as to associated the communications to a comment id. However, the URL sent from the application A (to application B) may also include complex “continuation” information encoded in the URL, i.e., so as to dictate further action effected upon receipt of the URL by application B, i.e., such as delivery instructions. A URL from application A to application B might be constituted by, for example, the URL:
myorder://order/1.0.0/?orderNumber=123&returnURL=CoffeePlaceurl %3A%2F%2F%3Fbeverage_id %3D123

As shown in FIG. 25, step 214 reflects that when Application B is done performing the dictated processing (as dictated by the URL from application A), Application B invokes the returnURL, that was provided from Application A, and attaches any additional information, e.g. such as information generated from the processing performed by application B and information regarding whether the order was completed. In other words, application B prepares the return URL (and associated information) for retrieval by the customer's application A.

Accordingly, when the customer taps “Return to CoffeePlace” as presented by application A on the customer's device, application A invokes the returnURL of the request, which includes the additional return parameters that indicate whether the order was completed as well as any other information generated by application B. In accordance with one embodiment of the invention, the return parameters are prefixed with an appropriate prefix, i.e., to avoid collisions.

The return URL might be constituted by, for example, the URL:
CoffeePlace-url://?beverage_id=123&sbux_responseType=completed

Accordingly, in step 216 of FIG. 25, Application A retrieves the returnURL, restoring the “continuation” of the processing. When the CoffeePlace web page re-launches with the requested URL, the CoffeePlace web page loads the correct record using the beverage_id parameter, and further may store information about the transaction in the Notes field for that record.

The above protocol provides one approach that may be used in the communications between the MO processing portion 200 and the merchant system 130. In general, the above protocol may be used in conjunction with any of the communications described herein, as desired.

Hereinafter, general aspects of implementation of the systems and methods of the invention will be described.

As described herein, embodiments of the system of the invention and various processes of embodiments of the method of the invention are described. The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A computer implemented method for fulfilling a customer request for a requested item purchased from a merchant, the method performed by a computer processor, the method including:
inputting trigger data, by the computer processing machine, from a customer mobile device, the trigger data reflecting an event of the customer device, wherein the event comprises the customer device coming within a predetermined proximity to the merchant, thereby causing creation of the trigger data, the trigger data initiating the customer request for the requested item to be transmitted from the customer mobile device, the trigger data corresponding to and being synonymous with at least a portion of an observed event data, the observed event data comprising proximity data and being established by the customer and stored in the customer mobile device prior to the inputting the trigger data, wherein a first set of observed events are mapped to a first trigger to initiate an order of a first corresponding item and a second set of observed events are mapped to a second trigger to initiate an order of a second corresponding item;
associating, by the computer processing machine, the observed event data with a corresponding order record, the corresponding order record also being stored in the customer mobile device prior to the inputting the trigger data;
retrieving, by the computer processing machine, order information from the corresponding order record, the order information including requested item information and merchant information;
generating, by the computer processing machine, a merchant request based at least in part on the order information in the corresponding order record, the merchant request including customer identification information, merchant information reflecting a designated merchant, and requested item information; and
outputting, by the computer processing machine, the merchant request to the designated merchant, so as to provide the designated merchant with information to fulfill the customer request, such that both the customer request is prepared and an associated financial transaction is completed prior to the merchant system interfacing with the customer at the physical premise of the merchant.

2. The method of claim 1, further including:
generating a transaction request to secure a debit of an account of the customer to fund the customer request, the transaction request based at least in part on the order information in the corresponding order record, the transaction request including customer account information and a debit amount for the requested item; and
interfacing with a bank processing portion to secure approval of the transaction request.

3. The method of claim 2, wherein the generating the transaction request and the interfacing with a bank processing portion to secure approval of the transaction request, are performed by the merchant, subsequent to receiving the merchant request.

4. The method of claim 2, wherein the generating the transaction request and the interfacing with a bank processing portion to secure approval of the transaction request, are performed by a processor disposed in the customer mobile device, prior to the customer mobile device sending the merchant request.

5. The method of claim 1, wherein the customer mobile device is a cell phone.

6. The method of claim 1, wherein the customer mobile device is one of a PDA (personal digital assistant) and a smart phone.

7. The method of claim 1, wherein the customer mobile device is an electronic texting device.

8. The method of claim 1, wherein the trigger data further comprises a key sequence input from the customer mobile device.

9. The method of claim 1, wherein the trigger data further comprises an icon selection input from the customer mobile device.

10-28. (canceled)

29. The method of claim 1, wherein the trigger data further comprises a calendar event input from the customer mobile device.

30. The method of claim 1, wherein the approval of the transaction request is received prior to generation of the merchant request.

31. The method of claim 1, wherein the designated merchant is designated based on a merchant's geographic location vis-à-vis the location of the customer.

32. The method of claim 1, wherein the designated merchant is designated based on a selection of the merchant's address.

33. The method of claim 1, the computer processing machine disposed in the customer mobile device.

34. A computer processing machine for fulfilling a customer request for a requested item purchased from a merchant, the computer processing machine comprising:
a communication portion that inputs trigger data from a customer mobile device, the trigger data reflecting an event of the customer device, wherein the event comprises the customer device coming within a predetermined proximity to the merchant, thereby causing creation of the trigger data, the trigger data initiating the customer request for the requested item, the trigger data corresponding to and being synonymous with at least a portion of an observed event data, the observed event data comprising proximity data and being established by the customer and stored in the customer mobile device prior to the inputting the trigger data; and
a merchant request generation portion, which is in the form of a tangibly embodied processing portion of the computer processing machine, that:
associates the observed event data with a corresponding order record, the corresponding order record also being stored in the customer mobile device prior to the inputting the trigger data;
retrieves order information from the corresponding order record, the order information including requested item information and merchant information;
generates a merchant request based at least in part on the order information in the corresponding order record, the merchant request including customer identification information, merchant information reflecting a designated merchant, and requested item information; and
outputs the merchant request to the designated merchant, so as to provide the designated merchant with information to fulfill the customer request, such that both the customer request is prepared and an associated financial transaction is completed prior to the merchant system interfacing with the customer at the physical premise of the merchant.

35. The computer processing machine of claim 34, the communication portion and the merchant request generation portion disposed in the customer mobile device.

36. The computer processing system of claim 34, further including a merchant system that inputs the merchant request from the merchant request generation portion, the merchant system processing the merchant request to fulfill the merchant request, the merchant system constituted by a further tangibly embodied processing machine.

37. The computer processing system of claim 36, the merchant system generating a transaction request, and sending the transaction request to a bank entity, to secure a transfer of funds for the requested item.

38. The computer processing system of claim 36, the merchant system generating a tab in the form of a physical tab to be associated with the requested item, the tab containing particulars of the customer request.

39. The computer processing system of claim 38, the merchant system further generating targeted advertising information based on attributes of the customer, the tab to be associated to the requested item including the targeted add information.

40. The computer processing system of claim 38, the tab to be associated to the requested item including an adhesive portion to affix the tab to the requested item.

41. The computer processing system of claim 38, the merchant request to the designated merchant being in the form of a URL string that includes a return URL portion.

42. The computer processing system of claim 41, the merchant request generation portion invoking the return URL portion to secure information regarding the processing of the customer request as performed by the merchant system, subsequent to the merchant system processing the URL string.

43. A non-transitory, tangibly embodied computer readable medium including machine readable code that fulfills a customer request for a requested item purchased from a merchant, the tangibly embodied computer readable medium constituting a portion of a computer processing machine, the tangibly embodied computer readable medium comprising:
a communication portion, of the computer processing machine, that inputs trigger data from a customer mobile device, the trigger data reflecting a singular specific event experienced by the customer device, wherein the event comprises the customer device coming within a predetermined proximity to the merchant, thereby causing creation of the trigger data, the trigger data constituting the customer request to initiate a transaction to purchase the requested item, the trigger data corresponding to and being synonymous with at least a portion of an observed event data, the observed event data comprising proximity data and being established by the customer and stored in the customer mobile device prior to the inputting the trigger data; and
a merchant request generation portion, of the computer processing machine, that:
associates the observed event data with a corresponding order record, such corresponding order record is constituted by a singular specific data record, the corresponding order record also being stored in the customer mobile device prior to the inputting the trigger data, and
such associating the observed event data with the corresponding order record is constituted by a one to one mapping of the singular specific event to the singular specific data record;
retrieves order information from the corresponding order record, the order information including requested item information that identifies the identity of the requested item to be purchased, the order information further including merchant information that identifies the particular merchant from which the requested item is to be purchased;
generates a merchant request based at least in part on the order information in the corresponding order record, the merchant request including customer identification information, merchant information reflecting a designated merchant, and requested item information; and
outputs the merchant request to the designated merchant, so as to provide the designated merchant with information to fulfill the customer request, such that both the customer request is prepared and an associated financial transaction is completed prior to the merchant system interfacing with the customer at the physical premise of the merchant.

44. The method of claim 1, wherein the requested item is one of a goods and services.

45. The computer processing system of claim 36, the merchant system generating indicia disposed on a physical medium, the physical medium to be disposed upon the requested item, the physical medium containing particulars of the customer request.
